(19) United States
(12) Patent Application Publication
(10) Pub. No.: US 2020/0064213 A1
(43) Pub. Date: Feb. 27, 2020

(54) CAPACITANCE MANOMETER FOR HIGH TEMPERATURE ENVIRONMENTS

(71) Applicant: Global Solar Energy, Inc., Tucson, AZ (US)

(72) Inventor: Scott WIEDEMAN, Tucson, AZ (US)

(73) Assignee: Global Solar Energy, Inc., Tucson, AZ (US)

(21) Appl. No.: 16/110,652

(22) Filed: Aug. 23, 2018

(51) Int. Cl. G01L 9/00; G01L 13/02

(52) U.S. Cl. CPC G01L 9/0072; G01L 13/025

(57) ABSTRACT

Differential capacitance manometers of the present disclosure may include a graphite baffle secured at one end and free at the other end, such that the baffle flexes toward and away from a pair of counter electrodes in the presence of a differential pressure. Because one of the electrodes is disposed closer to the free end of the baffle, a difference exists in the capacitance between the baffle and each of the electrodes, and this difference changes depending on the displacement of the baffle.

### FIELD

This disclosure relates to systems and methods for sensing pressures in vacuum environments. More specifically, the disclosed embodiments relate to capacitance manometers.

### INTRODUCTION

For many vacuum deposition processes the vapor pressure of a constituent in a vacuum chamber must be measured or controlled. Various gauges exist for this purpose, including ion gauges (based on thermal ion creation), Pirani gauges (based on thermal conductance), Penning gauges (based on plasma ionization), and capacitance manometer types. However, ion gauges serve only in a limited low pressure range and are subject to contamination. Thermal conductance gauges are often inaccurate. Penning gauges suffer the same drawbacks as ion gauges. Known capacitance manometers are unsuited for operation in extreme environments, e.g., in the presence of high temperatures or harsh, corrosive reactants.

Some existing capacitance manometers are intended for “high temperature” use. However, these gauges are rarely operated above 125-150° C., and they may be “baked out” at higher temperatures. Moreover, none of the known commercial capacitance manometers are intended for use in harsh chemical environments, such as those that entail corrosive and condensing selenium and the like.

### SUMMARY

The present disclosure provides systems, apparatuses, and methods relating to capacitance manometers configured to operate in ranges up to 1000° C. or more, and/or in corrosive environments.

In some embodiments, a capacitance manometer may include a flexible, electrically-conductive baffle including an expanse secured at a proximal end and free at a distal end, the expanse having a first face and a second face; and a first electrode spaced apart from a second electrode adjacent the second face of the baffle; wherein the first electrode is closer than the second electrode to the proximal end of the baffle; and wherein the proximal end of the baffle is fixed relative to the first and second electrodes, such that the expanse is configured to flex toward and away from the first and second electrodes with a magnitude of flexion corresponding to a differential pressure across the first and second faces of the baffle.

In some embodiments, a system for measuring differential vacuum pressure may include a capacitance manometer including a first electrode and a second electrode adjacent a flexible, electrically-conductive baffle secured at a proximal end and free at a distal end, such that the distal end of the baffle is configured to flex toward and away from the first and second electrodes with a magnitude of flexion corresponding to a differential pressure across the baffle; a time-varying voltage source coupled to the baffle, such that the baffle forms a first capacitor in combination with the first electrode and a second capacitor in combination with the second electrode; and a measuring circuit configured to receive a first current measured on the first electrode and a second current measured on the second electrode, and to convert a difference between the first and second currents into a measurement of the differential pressure across the baffle.

In some embodiments, a method for measuring differential vacuum pressure between two compartments may include sensing, using a capacitance manometer, a differential pressure between a first compartment and a second compartment, wherein the capacitance manometer includes a first electrode and a second electrode adjacent a flexible, electrically-conductive baffle secured at a proximal end and free at a distal end, such that the distal end of the baffle is configured to flex toward and away from the first and second electrodes with a magnitude of flexion corresponding to the differential pressure; producing a first current in the first electrode and a second current in the second electrode by applying a time-varying voltage source to the baffle of the capacitance manometer, such that the baffle forms a first capacitor in combination with the first electrode and a second capacitor in combination with the second electrode; and converting a difference between the first current and the second current into a measurement of the differential pressure.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram of an illustrative multi-chamber process including a sensor according to the present teachings.

FIG. 2 is an isometric view of an illustrative differential capacitance manometer in accordance with aspects of the present disclosure.

FIG. 3 is another isometric view of the differential capacitance manometer of FIG. 2.

FIG. 4 is an isometric view of a cap portion of the housing of the differential capacitance manometer of FIG. 2.

FIG. 5 is an isometric view of the differential capacitance manometer of FIG. 2, with the cap portion removed.

FIG. 6 is an isometric exploded view showing various components of the differential capacitance manometer of FIG. 2.

FIG. 7 is an isometric view of selected operational components of the differential capacitance manometer of FIG. 2.

FIG. 8 is a block diagram of an illustrative system incorporating the differential capacitance manometer of FIG. 2.

FIG. 9 is a flow chart depicting steps of an illustrative method for measuring vacuum pressures according to the present teachings.

### DETAILED DESCRIPTION

Various aspects and examples of a capacitance manometer configured to operate reliably in high temperature and/or highly corrosive environments, as well as related systems and methods, are described below and illustrated in the associated drawings. Unless otherwise specified, a capacitance manometer in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections A and B, each of which is labeled accordingly.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Coupled” means connected, either permanently or releasably, whether directly or indirectly through intervening components.

“Resilient” describes a material or structure configured to be deformed elastically under normal operating loads (e.g., when compressed) and to return to an original shape or position when unloaded.

“Rigid” describes a material or structure configured to be stiff, non-deformable, or substantially lacking in flexibility under normal operating conditions.

“Processing logic” may include any suitable device or hardware configured to process data by performing one or more logical and/or arithmetic operations (e.g., executing coded instructions). For example, processing logic may include one or more processors (e.g., central processing units (CPUs) and/or graphics processing units (GPUs)), microprocessors, clusters of processing cores, FPGAs (field-programmable gate arrays), artificial intelligence (Al) accelerators, digital signal processors (DSPs), and/or any other suitable combination of logic hardware.

### Overview

Capacitance manometers according to the present disclosure solve the problem of operating a differential pressure gauge in a harsh, high temperature environment. This is accomplished by using mechanically and chemically stable construction materials with high sensitivity. Differential capacitance manometers taught herein are particularly applicable when a differential measurement will suffice, such as when the low vacuum pressure inside a chamber (e.g., reaction zone) is to be measured relative to another low or negligible vacuum pressure outside that chamber. Manometers may be interchangeably referred to herein as pressure measuring devices, pressure gauges, and/or pressure sensors.

In general, pressure measuring devices of the present disclosure include a differential capacitance sensor having a thin, electrically-conductive (e.g., graphite) plate or baffle that is disposed on one side of a pair of stationary counter electrodes. The baffle is fixed at one end, free at the other end, and is situated close to the counter electrodes. Accordingly, the baffle is configured to flex toward and away from the electrodes depending on sensed pressures. Each electrode effectively forms an independent capacitor in combination with the baffle. As the baffle flexes, distances between the baffle and the two counter electrodes are modulated, altering capacitances of the two capacitors differently. Baffle movement in response to differential pressure can be monitored accurately by measuring the relative capacitance change between the two capacitors. Capacitance of one capacitor will change more than the other due to the paddle flexing more at the free side as compared with the fixed side.

The pressure measuring device is mounted in a housing that exposes one side of the graphite baffle to the higher pressure to be measured, and exposes the other side of the baffle to the reference pressure (typically the low or negligible pressure volume). As discussed above, the graphite baffle is formed in a paddle shape, and is held mechanically (e.g., to the housing) by clamping onto a small tab or projection extending from one edge of the baffle. Accordingly, the baffle is permitted to flex easily in response to a pressure difference across the baffle.

By constructing the sensor primarily using graphite materials, operation in harsh, high temperature and/or corrosive conditions is enabled. Graphite is unreactive with most harsh chemical constituents, such as selenium. It also withstands very high temperature environments (e.g., up to 1000° C. or more). Unlike metals, graphite is not subject to internal stresses that induce deformation upon temperature exposure. Graphite is mechanically and chemically stable, has a high yield stress at high temperatures, and has a favorable elastic modulus that gives reproducible flexing behavior due to pressure variations. Contamination on gauge components can be avoided in some cases (e.g., in selenium environments) by actively heating the gauge components to prevent material condensation.

Although graphite components are described herein, other materials may be utilized in some embodiments, either alternatively or additionally. Examples of suitable materials may include crystalline silicon, silicon carbide, alumina (aluminum oxide), aluminum nitride, and/or boron nitride. These materials withstand high temperatures and are fairly inert chemically. However, some have insulating qualities. This presents a potential issue because the baffle, for example, is intended to be electrically-conductive. This drawback may be resolved, e.g., by coating at least one side of the baffle (e.g., the disk portion) with a thin metallic layer. For example, an inert, high temperature metal (e.g., molybdenum, tungsten, iridium, rhenium, niobium, tantalum, gold, or the like) may be sputtered or evaporated onto the component(s). In some examples, the metallic coating may comprise a conductive oxide, such as indium-tin oxide.

Differential pressure gauges or manometers of the present disclosure include a baffle that has a secured proximal end and a free distal end, such that the baffle flexes in the presence of a differential pressure. Due to flexion of the baffle at an angle relative to its attachment point, this results in different changes in capacitance between the flexing baffle and two separated electrodes disposed nearby. In some embodiments, the capacitance manometers can operate at temperatures up to 1000° C. and/or in a harsh, corrosive chemical environment.

In many applications (e.g., absolute manometers), a constant reference pressure is required on one side of a diaphragm. This may include an evacuated volume, with a deposit of reactive material (known as a “getter”) intended to complete and maintain the vacuum. In these examples, the real pressure may be obtained in absolute terms. However, the diaphragm separating the measured and reference volumes in these examples must provide a perfect leak-tight seal. In other words, the edges of the diaphragm are rigidly held by the sealing surface, and thus the movement of the diaphragm is limited to slight flexing of the material near the center of the diaphragm. Accordingly, the movement (and thus sensitivity) is much lower than that of the present disclosure, where the entire diaphragm is free to deflect on a narrow cantilever, rather than only a center portion with the edges fixed.

In the present disclosure, the reference vacuum pressure is assumed to be supplied, existing, and/or maintained actively on the backside of the sensor, and communicated to the backside of the paddle by open passages through the device. A difference in pressure is measured, i.e., relative front side to back side pressure. The CIGS chambers described briefly below operate under this scenario.

Without a complete edge seal, there is some gas leakage from the measured volume to the reference volume. However, in situations where both volumes are actively pumped and controlled, or at least where the reference volume pressure can be maintained, a small amount of leakage is inconsequential.

Systems of the present disclosure may be particularly useful at low pressures (e.g., <10 mTorr). Gas density at these pressures is around 100,000 times less than atmospheric pressures, and many of the effects ascribed to a viscous moving fluid with a significant mass and momentum (e.g., Bernoulli effects) are absent. Gas becomes an ensemble of particles. A “rule of thumb” may be used, approximating the mean free path (in cm) as 5/P, where P is pressure in mTorr. Accordingly, a mean free path longer than approximately five mm is larger than the leakage paths behind the paddle-shaped baffle. Gas molecules generally are not interacting with each other to produce a directed stream having mass and momentum.

Nevertheless, devices of the present disclosure may be suitable for applications near atmospheric pressure, where extremely small differences in pressure must be measured. At the small pressure differences measurable with these devices, the pressure difference between front-to-back is small enough that there would not be significant flow around the baffle, and thus no real effects due to the flow.

### Examples, Components, and Alternatives

The following sections describe selected aspects of exemplary differential capacitance manometers, as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. Illustrative Differential Capacitance Manometer

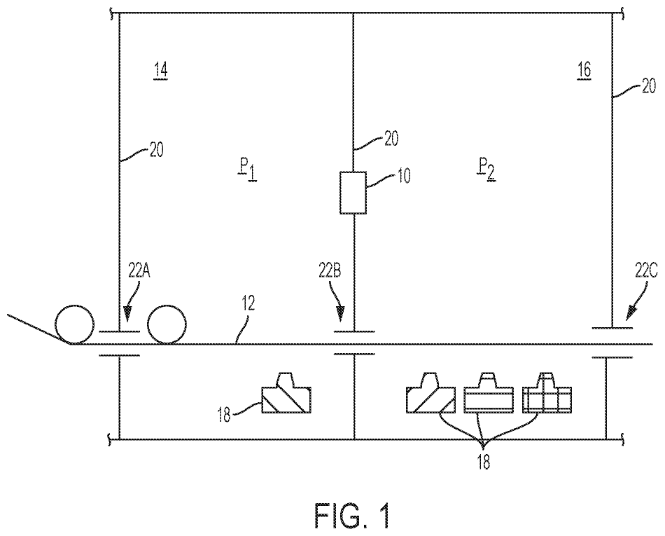

As shown in FIGS. 1-8, this section describes an illustrative robust differential capacitance manometer 10 suitable for measuring selenium vapor pressures in a high-temperature vacuum environment. Manometer 10, also referred to as a sensor, is an example of the differential capacitance manometers described in the Overview above.

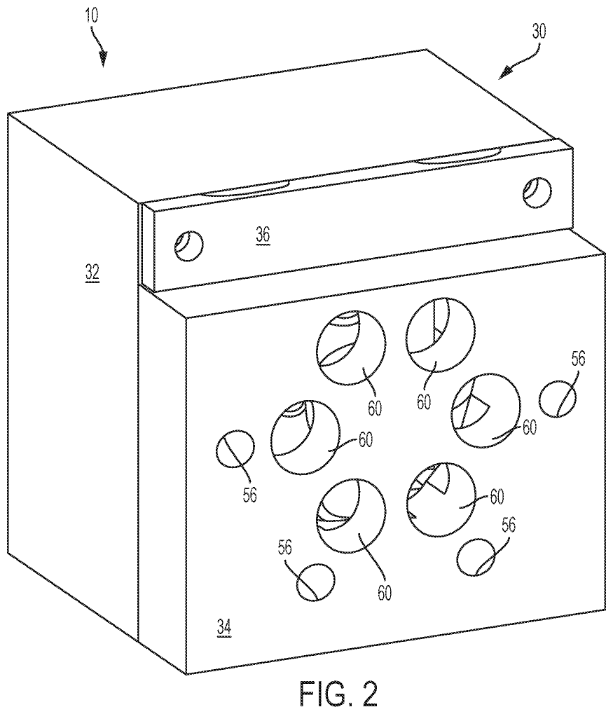

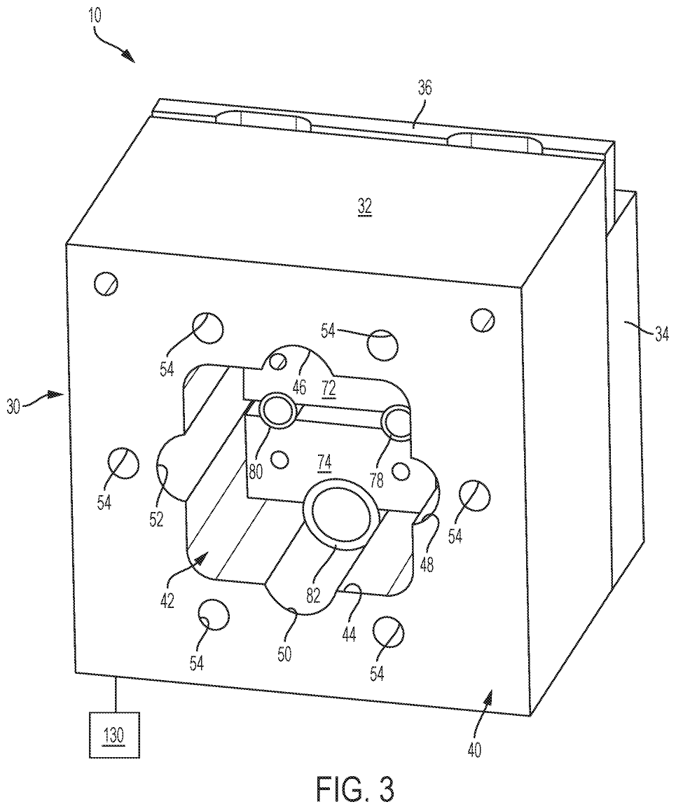

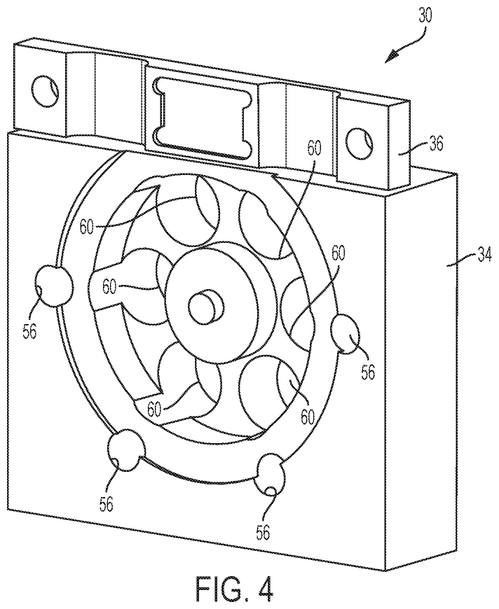

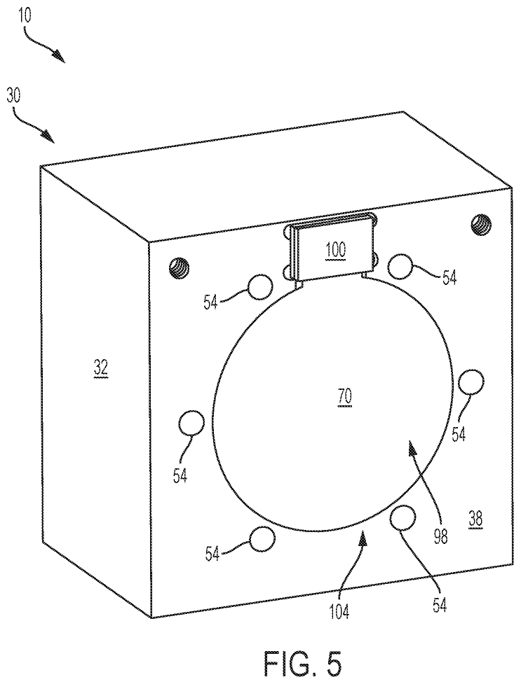

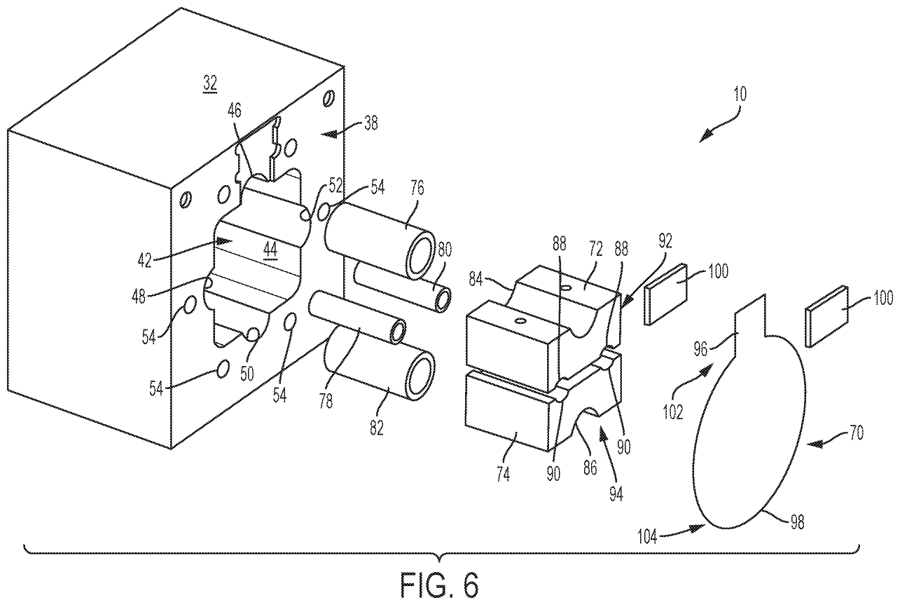

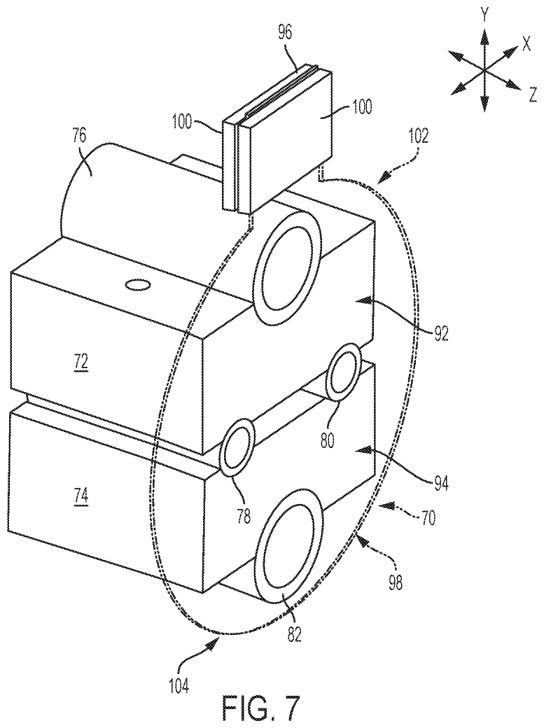

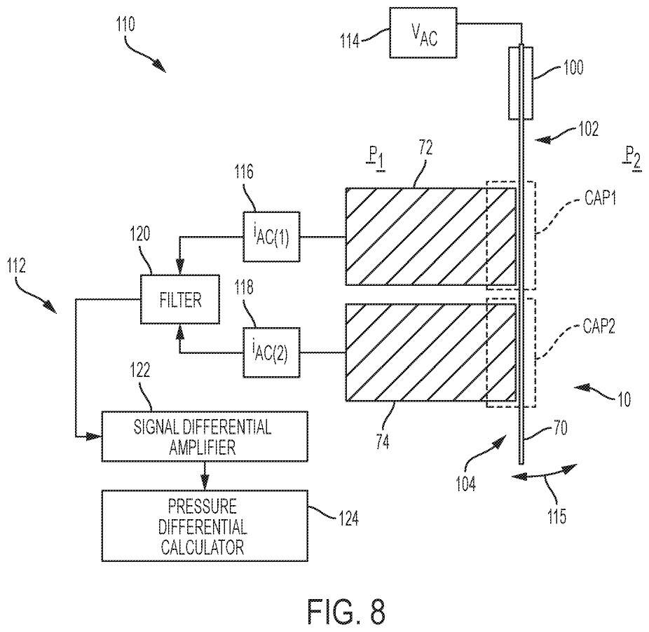

FIG. 1 is a schematic diagram of an illustrative environment in which manometer 10 may be used. FIGS. 2 and 3 are isometric views of manometer 10 from different vantage points. FIG. 4 shows the manometer with a portion of the housing removed, showing relationships between various components. FIG. 5 is an exploded view of manometer 10. FIG. 6 is an isometric view of an inner side of a portion of the housing. FIG. 7 is an isometric view of selected operational components of manometer 10. FIG. 8 is a schematic block diagram describing the overall functionality of manometer 10.

FIG. 1 depicts a portion of a manufacturing system for flexible photovoltaics, in which a flexible substrate 12 (AKA the web) travels through a series of deposition regions or zones, all contained within a common chamber. Specifically, an evaporation zone has a first region 14, which includes NaF deposition using thermal evaporation, as well as a Cu/In/Ga deposition region 16, which includes the vapor-delivery of copper, gallium, and indium. Deposition regions 14 and/or 16 include heated effusion sources 18 for generating plumes of vapor derived from these materials. Each of these effusion sources may include any suitable apparatus configured to produce a vapor plume. Cu, In, and Ga are often deposited using a vacuum-reactive coevaporation process, in which a significant excess or overpressure of selenium (Se) is maintained over a growing film on the web.

Although a vacuum exists throughout the system, internal vacuum isolation walls 20 are included to segregate the chamber, such that different levels of vacuum and/or temperature, or different gas species, may be maintained in different subchambers. At each location where substrate 12 is required to pass through one of the inner vacuum isolation walls, a conductance slot (i.e., conductance slots 22A, 22B, and 22C) may be included to permit the transit of substrate 12 from one part of the chamber to another. Conductance slots 22A, 22B, 22C (AKA conductance restrictions) are configured to limit the efficient movement of gas atoms from one side to the other.

As shown in FIG. 1, manometer 10 may be disposed in this sort of system, e.g., in wall 20, such that one side of the device is exposed to a pressure P1 in a first chamber (i.e., region 14), while another side of the device is exposed to a pressure P2 in a second chamber (i.e., region 16). Accordingly, a differential pressure between the two chambers can be measured. If pressure in one chamber is known (or effectively known, or assumed to be known), this also facilitates determination of pressure in the other chamber.

With continuing reference to FIGS. 2-8, manometer 10 includes a housing 30, which has a housing body 32 (AKA the sensor body) and a housing cap 34, as well as a stress bridge portion 36. Housing 30 may include any suitable structure(s) that are stable under expected operating conditions and configured to securely hold and protect the inner components of the sensor in their desired orientations and positions, while exposing both sides of the baffle (described below) more or less to the surrounding environment or environments. In this example, the components of the housing are made primarily or entirely of graphite, to withstand high temperatures and chemical corrosion, while remaining mechanically stable.

Housing body 32 is a block (e.g., a cuboidal block) having a first face 38 (AKA the front face) and a second face 40 (AKA the back face), with an inner compartment 42 formed by a void in the block. Compartment 42 is open at both face 38 and face 40, defining a large aperture that passes through the block. As depicted in FIGS. 3 and 5, a perimeter wall 44 of the compartment generally defines a square shape having rounded corners, with a semi-circular channel 46, 48, 50, 52 formed in each otherwise flat side of the square. Although compartment 42 has a rounded-square perimeter in this example, any suitable shape may be utilized. Similarly, although semicircular channels are present in this example, the channels may have any suitable shape or cross-section, corresponding to components held within the channels (see below). In some examples, more or fewer channels may be present.

A plurality of through holes 54 is formed in body 32, with corresponding through holes 56 in cap 34. Accordingly, when housing 30 is fully assembled, holes 54 and 56 align with each other to provide limited fluid communication around the central compartment. Other fastener holes and various mounting structures may also be present, to facilitate attachment of the various portions of the device.

As best viewed in FIGS. 2 and 4, cap 34 couples with first face 38 of body 32, and has a plurality (six, in this example) of openings 60 providing fluid communication through the cap and into (or out of) body 32. Openings 60, in this example, are circular holes formed in cap 34 and arranged in a circular pattern aligned generally with compartment 42. Any suitable shape and/or number of openings 60 may be utilized. In general, cap 34 may include any suitable structure configured to allow fluid communication with the internal components of the sensor while also providing mechanical protection for the internal components.

Turning to FIGS. 5-7, internal components of manometer 10 are housed by housing 30, and include a baffle 70, a first electrode block 72, a second electrode block 74, and insulating separators 76, 78, 80, 82 (AKA spacers). Electrode block 72 and electrode block 74 are arranged adjacent each other within compartment 42. The electrode blocks may comprise any suitable material that is mechanically stable and conductive while able to withstand high temperatures and a chemically corrosive environment. In this example, each electrode block is made of graphite.

The two electrodes are physically and electrically separated from each other by separators 78 and 80. The two electrodes are also physically and electrically separated from perimeter wall 44 of body 32 by separators 76 and 82. In this example, all of the separators are tubes or cylinders having a circular cross section. However, the separators may include any suitable insulating material(s), in any suitable shape(s). The tubular structures in this example are lengths of alumina ceramic tube. Alumina ceramic can withstand high temperature, is inexpensive, mechanically stable, and provides insulated support to hold the graphite electrodes securely. Each of the tubes is oriented such that an open end is adjacent the baffle, to reduce interference through the compartment.

In some examples, more or fewer separators may be utilized. Here, separators 76 and 82 are received into channels 46 and 50 of the housing, and corresponding channels 84 and 86 in electrode blocks 72 and 74, respectively. Similar channels 88 and channels 90 are formed in the electrode blocks for receiving separators 78 and 80. Accordingly, when assembled, electrode block 72 and electrode block 74 are held in electrical isolation and in fixed positions relative to each other and relative to housing 30. In this example, a planar face 92 of electrode block 72 is substantially aligned with a planar face 94 of electrode block 74, such that face 92 and face 94 are coplanar. Faces 92 and 94 are oriented such that they are associated with first face 38 of housing body 32. In some examples, the faces may be offset by a selected amount, i.e., not coplanar.

As shown in FIGS. 5-7, baffle 70 is disposed adjacent the electrodes, covering (but spaced from) the opening of compartment 42 at first face 38. Baffle 70 is a planar, paddle-shaped thin plate or sheet oriented parallel to first face 38, as well as to faces 92 and 94 of the electrodes. Moreover, baffle 70 is a unitary structure including a tab 96 extending from a circular expanse 98 (AKA a disk) having a front and a back face. Baffle 70 may include any suitable expanse of electrically conductive material configured to flex resiliently in the presence of a differential pressure, and may have any suitable size and/or shape. Here, baffle 70 is made of graphite, and tab 96 is fastened to the housing by a fastener. Here, the fastener includes a clamping mechanism, where the tab is held between a pair of insulating (e.g., ceramic) plates 100, which are secured in place by stress bridge portion 36. Accordingly, the remainder of baffle 70 is free to flex toward and away from electrode block 70 and electrode block 72 (e.g., as a result of a pressure gradient). Because of the clamping described above, more movement of baffle 70 will be experienced near a distal end 104 of the baffle than near a proximal end 102. Generally speaking, the baffle may be said to pivot or bend at the proximal end, although the actual movement need not be around a discrete pivot axis.

FIG. 8 is a schematic diagram of an illustrative sensor system 110 that utilizes manometer 10 to measure a differential pressure. As shown in FIG. 8, system 110 includes a circuit 112 (e.g., including processing logic) configured to convert a measured difference in capacitance from manometer 10 to a differential pressure. Circuit 112 may include any suitable combination of hardware and software, or may be entirely hardware or entirely software.

In this example, system 110 includes a voltage source 114 that applies an alternating current (AC) voltage, designated VAC in FIG. 8, to tab 96 of baffle 70, e.g., through a metal foil contact (not shown). Although an AC voltage is applied in this example, any suitable excitation signal may be applied. As depicted throughout the drawings, baffle 70 is disposed adjacent to electrodes 72 and 74, with a small gap between the baffle and the faces of the electrodes. This effectively results in a pair of capacitors, with a first capacitor CAP1 being formed by baffle 70 and electrode 72 and a second capacitor CAP2 being formed by baffle 70 and electrode 74. The gap is variable, as distal end 104 of the baffle moves toward and away from the electrodes (see arrow 115), thereby varying the capacitance of CAP1 and CAP2. However, the capacitances do not vary identically. By securing proximal end 102 and creating a cantilever effect, baffle 70 can only move at an angle instead of translating in and out as a whole. Accordingly, the capacitance of the two capacitors will vary by different amounts for any given movement of the baffle. For the purposes of this description, it is assumed that the baffle moves due to a differential pressure across the baffle, i.e., a difference between P1 and P2, where a higher P2 causes the baffle to move toward the electrodes and a higher P1 causes the baffle to move away from the electrodes.

As a result of VAC and the capacitive effects, a first AC current 116 is detected at electrode 72, and a second AC current 118 is detected at electrode 74. Specifically, a small AC voltage from an oscillator is impressed on the baffle (e.g., approximately 2-5 VAC at 40 kHz), which causes an AC current at that frequency across both capacitors CAP1 and CAP2. The small AC currents 116 and 118 are amplified (e.g., by solid state circuitry) and bandpass filtered to reduce noise. This operation is represented by block 120 of FIG. 8. The filtered and amplified signals corresponding to current 116 and current 118 are then input to a differential amplifier 122, such that only the difference between the two signals is amplified.

A signal proportional to the pressure differential is then generated, such that pressure-related values can be calculated at block 124. In some examples, the difference signal is put into a synchronous amplifier, and the weak difference signal is amplified by a positive factor for half of the period of the oscillator waveform, and by an equal negative factor during the other half period of the wave form. This is then integrated to a DC value and amplified again.

This approach facilitates recovery of extremely small signals that are buried in noise. The sensor itself produces a differential signal in response to a very small pressure on the paddle, because the paddle farther from the cantilever mount naturally deflects more than the paddle nearest the mount. The capacitance can be approximated by epsilon*A/D where epsilon is the dielectric constant of the material (vacuum) in the capacitance gap, A is the area of the rectangular electrode, and D is the distance of separation between the baffle and each electrode. Accordingly, the capacitance of the farther electrode changes more than the capacitance of the nearer electrode, and a difference signal is generated proportional to the pressure variation. This difference signal can be isolated from common-mode noise, using the technique described above.

In operation, the baffle responds to a pressure difference in either direction (i.e., high-to-low on either side of the baffle). Accordingly, the sensor may be mounted in any orientation with respect to the two chambers or regions in question. However, it may be advantageous for the sensor to be oriented with high pressure on the exposed side of the baffle (i.e., away from the counter electrodes). This is because the entire paddle-shaped area is then exposed to the pressure to be measured, without restriction to gas flow around the electrodes, etc. In addition, in a transient situation with a very high pressure (e.g., out of measurement range), the baffle in this orientation will simply “bottom out” when it hits the electrodes. Damage would be minimal or nonexistent. Although the capacitors are expected to short out in this situation, the small AC signal will also be shorted, and the circuit is configured to detect the short and display an error. When the low pressure is on the exposed side of the baffle (i.e., the sensor is facing the other way), then a burst of pressure applied to the backside of the baffle may deflect it beyond its breaking point.

As noted above, manometer 10 and system 110 may operate in harsh environments, including those that normally result in the condensation of solids onto the sensor. In some cases, such as in the presence of selenium or other condensing compounds, a heat source 130 (e.g., a heater or cartridge heater) (see FIG. 3) may be incorporated or added to the system to heat various components subject to selenium condensation. For example, a cartridge heater may be inserted into a bore somewhere in the sensor body, or a heating device may be incorporated into the cap. Heat source 130 may include any suitable heating device or mechanism configured to raise the temperature of exposed components of the manometer. In some examples, an integral heating element is included, e.g., in the housing of the manometer. In some examples, the integral heating element may be configured to raise a temperature of the manometer above ambient temperature.

Based on and in company with the description above, additional aspects and features of capacitance manometers and related systems are presented below, without limitation, as a series of paragraphs alphanumerically designated for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations.

A0. A capacitance manometer (e.g., manometer 10) comprising:

a flexible, electrically-conductive baffle (e.g., baffle 70) including an expanse (e.g., expanse 98) secured at a proximal end and free at a distal end, the expanse having a first face and a second face; and

a first electrode spaced apart from a second electrode (e.g., electrode blocks 72, 74) adjacent the second face of the baffle;

wherein the first electrode is closer than the second electrode to the proximal end of the baffle; and

wherein the proximal end of the baffle is fixed relative to the first and second electrodes, such that the expanse is configured to flex toward and away from the first and second electrodes with a magnitude of flexion corresponding to a differential pressure across the first and second faces of the baffle.

A1. The capacitance manometer of A0, further comprising:

a time-varying (e.g., alternating-current) voltage source coupled to the baffle, such that the baffle forms a first capacitor (e.g., CAP1) in combination with the first electrode and a second capacitor (e.g., CAP2) in combination with the second electrode; and

a circuit (e.g., circuit 112) configured to receive a first current measured on the first electrode and a second current measured on the second electrode, and to convert a difference between the first and second currents into a measurement of the differential pressure across the first and second faces of the baffle.

A2. The capacitance manometer of A1, wherein a second capacitance of the second capacitor changes by a greater amount than a first capacitance of the first capacitor, for a given magnitude of flexion of the expanse.

A3. The capacitance manometer according to any one of paragraphs A0 through A2, further comprising:

a tab extending from the proximal end of the baffle; and

a fastener securing the tab of the baffle, such that the proximal end of the baffle is fixed relative to the first and second electrodes and a distal end of the baffle is free to move toward and away from the first and second electrodes.

A4. The capacitance manometer according to any one of paragraphs A0 through A3, wherein the baffle comprises graphite.

A5A. The capacitance manometer of A4, wherein the baffle consists essentially of graphite.

A5B. The capacitance manometer of A4, wherein the baffle consists of graphite.

A6. The capacitance manometer according to any one of paragraphs A0 through A5B, wherein the first and second electrodes are housed in a block of graphite (e.g., body 32) and the proximal end of the baffle is clamped to the block.

A7. The capacitance manometer of A6, wherein the proximal end of the baffle comprises an extension (e.g., tab 96), and the extension is clamped to the housing between a pair of insulating plates (e.g., plates 100).

A8. The capacitance manometer of A6, further comprising a plurality of insulating separators (e.g., separators 76, 78, 80, 82) electrically isolating the first and second electrodes from each other and from the graphite block.

A9. The capacitance manometer of A8, wherein each of the insulating separators comprises a ceramic tube having an open end adjacent the second face of the baffle.

A10. The capacitance manometer of A6, wherein the first and second electrodes are housed in an open-ended compartment passing through the block.

A11. The capacitance manometer according to any one of paragraphs A0 through A10, wherein the first and second electrodes have respective ends (e.g., faces 92, 94) adjacent the baffle, and the respective ends are coplanar.

B0. A system for measuring differential vacuum pressure, the system comprising:

a capacitance manometer including a first electrode and a second electrode adjacent a flexible, electrically-conductive baffle secured at a proximal end and free at a distal end, such that the distal end of the baffle is configured to flex toward and away from the first and second electrodes with a magnitude of flexion corresponding to a differential pressure across the baffle;

a time-varying voltage source coupled to the baffle, such that the baffle forms a first capacitor in combination with the first electrode and a second capacitor in combination with the second electrode; and

a measuring circuit configured to receive a first current measured on the first electrode and a second current measured on the second electrode, and to convert a difference between the first and second currents into a measurement of the differential pressure across the first and second faces of the baffle.

B1. The system of B0, wherein the measuring circuit comprises a solid state circuit.

B2. The system according to any one of paragraphs B0 through B1, wherein the measuring circuit comprises processing logic configured to convert a difference signal corresponding to the difference between the first and second currents into a differential pressure measurement.

B3. The system according to any one of paragraphs B0 through B2, further comprising:

a tab extending from the proximal end of the baffle; and

a fastener securing the tab of the baffle, such that the proximal end of the baffle is fixed relative to the first and second electrodes.

B4. The system of according to any one of paragraphs B0 through B3, wherein the baffle comprises graphite.

B5. The system of B4, wherein the baffle consists of graphite.

B6. The system of according to any one of paragraphs B0 through B5, wherein the first and second electrodes are housed in a block of graphite and the proximal end of the baffle is clamped to the block of graphite.

B7. The system of B6, wherein the proximal end of the baffle comprises an extension, and the extension is clamped to the housing between a pair of insulating plates.

B8. The system of B6, further comprising a plurality of insulating separators electrically isolating the first and second electrodes from each other and from the graphite block.

B9. The system of B8, wherein each of the insulating separators comprises a ceramic tube having an open end adjacent the second face of the baffle.

B10. The system of B6, wherein the first and second electrodes are housed in an open-ended compartment passing through the block.

B11. The system of according to any one of paragraphs B0 through B10, wherein each of the first and second electrodes has a respective end adjacent the baffle, and the respective ends are coplanar.

In summary, pivoting, flexion, or bending of the baffle is caused by a differential pressure across the baffle, and that displacement causes a change in the capacitance of two capacitors formed by the baffle and a pair of electrodes. The change in the two capacitors is not identical, because the gap between the baffle and each capacitor changes differently as the baffle moves. This is due to one of the capacitors being closer to the (free) distal end of the baffle, which will move a greater amount than the (secured) proximal end. This difference in the capacitance change can be measured by applying a time-varying voltage to the baffle and measuring the resulting currents at each electrode. The difference between the currents is proportional to the difference in capacitance, which is proportional to the deflection of the baffle, which is proportional to the differential pressure. Accordingly, the differential pressure can be calculated using any suitable electronics and/or software. Using graphite (or the like) to construct the housing and baffle for the capacitance manometer facilitates proper functioning in high temperature and highly corrosive environments. Heating the device prevents condensation of solids (e.g., selenium).

### B. Illustrative Method

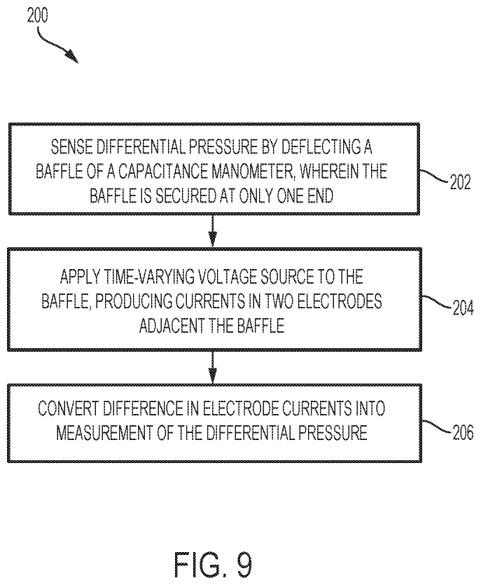

This section describes steps of an illustrative method 200 for measuring differential pressure (e.g., between two compartments) in a high temperature or otherwise harsh environment; see FIG. 9. Aspects of the differential capacitance manometers described above may be utilized in the method steps described below. Where appropriate, reference may be made to components and systems that may be used in carrying out each step. These references are for illustration, and are not intended to limit the possible ways of carrying out any particular step of the method.

FIG. 9 is a flowchart illustrating steps performed in an illustrative method, and may not recite the complete process or all steps of the method. Although various steps of method 200 are described below and depicted in FIG. 9, the steps need not necessarily all be performed, and in some cases may be performed simultaneously or in a different order than the order shown.

Step 202 includes sensing, using a capacitance manometer of the present disclosure, a differential pressure (e.g., between a first compartment and a second compartment) by deflecting a baffle of the manometer. As described above, the capacitance manometer includes a first electrode and a second electrode adjacent a flexible, electrically-conductive baffle. The baffle is secured at a proximal end and free at a distal end, such that the distal end of the baffle is configured to flex toward and away from the first and second electrodes. The magnitude of flexion corresponds to the differential pressure.

In some examples, the capacitance manometer has a tab extending from the proximal end of the baffle. A fastener is configured to secure the tab of the baffle, such that the proximal end of the baffle is fixed relative to the first and second electrodes. In some examples, method 200 further includes housing the first and second electrodes in a block of graphite, and clamping the proximal end of the baffle to the block of graphite. For example, the proximal end of the baffle may include an extension, and the extension may be clamped to the block of graphite between a pair of insulating plates.

In some examples, the baffle comprises graphite. In some examples, the baffle is made entirely or consists essentially of graphite. Each of the first and second electrodes may have a respective end adjacent the baffle, and the respective ends are coplanar. In some examples, the manometer further includes a plurality of insulating separators electrically isolating the first and second electrodes from each other and from the graphite block. These separators may be ceramic tubes each having an open end adjacent the baffle. The first and second electrodes may be housed in an open-ended compartment passing through the block.

Step 204 includes producing a first current in the first electrode and a second current in the second electrode by applying a time-varying voltage source to the baffle of the capacitance manometer. For example, an alternating current (AC) voltage may be applied to a tab or other portion of the baffle, e.g., through a foil contact sandwiched with the ceramic plates and the tab. The baffle forms a first capacitor in combination with the first electrode and a second capacitor in combination with the second electrode. For example, see CAP1 and CAP2 in FIG. 8.

Step 206 includes converting a difference between the first current and the second current into a measurement of the differential pressure. In some examples, this may be performed by solid state electronic circuit(s) and/or processing logic configured to receive the first current and the second current (signals corresponding to those currents). The circuit(s) and/or logic may be further configured to filter, amplify, and determine a difference between the two signals. The circuit(s) and/or logic may be further configured to calculate a differential pressure corresponding to this difference. In some examples, a reference pressure is known for one of the compartments being measured, such that the differential pressure may be converted to an absolute pressure of the other compartment.

Method 200 may further include preventing condensation (e.g., selenium condensation) on the capacitance manometer by heating the device. This may include heating the housing of the device, e.g., by inserting a heating element into a cavity of the manometer housing.

### Advantages, Features, and Benefits

The different embodiments and examples of capacitance manometers described herein provide several advantages over known solutions. For example, illustrative embodiments and examples described herein allow pressure measurement at temperatures up to 1000° C. or more, due e.g., to their graphite construction.

Additionally, and among other benefits, illustrative embodiments and examples described herein are constructed using graphite, which is mechanically and chemically stable, withstands high temperatures, is not subject to internal stresses that induce deformation upon temperature exposure, has a high yield stress at high temperatures, and has a favorable elastic modulus. These features allow the disclosed differential pressure gauges to operate in harsh, corrosive, and high temperature conditions

Additionally, and among other benefits, illustrative embodiments and examples described herein provide a reproducible flexing behavior in response to pressure variations.

Additionally, and among other benefits, illustrative embodiments and examples described herein prevent or reduce condensation (e.g., of selenium) by actively heating the device.

No known system or device can perform these functions, particularly in high temperature and/or corrosive environments. However, all embodiments and examples described herein may not provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

What is claimed is:

1. A capacitance manometer comprising:
a flexible, electrically-conductive baffle including an expanse secured at a proximal end and free at a distal end, the expanse having a first face and a second face; and
a first electrode spaced apart from a second electrode adjacent the second face of the baffle;
wherein the first electrode is closer than the second electrode to the proximal end of the baffle; and
wherein the proximal end of the baffle is fixed relative to the first and second electrodes, such that the expanse is configured to flex toward and away from the first and second electrodes with a magnitude of flexion corresponding to a differential pressure across the baffle.

2. The capacitance manometer of claim 1, further comprising:
an alternating-current (AC) voltage source coupled to the baffle, such that the baffle forms a first capacitor in combination with the first electrode and a second capacitor in combination with the second electrode; and
a circuit configured to receive a first current measured on the first electrode and a second current measured on the second electrode, and to convert a difference between the first and second currents into a measurement of the differential pressure across the first and second faces of the baffle.

3. The capacitance manometer of claim 1, further comprising:
a tab extending from the proximal end of the baffle; and
a fastener securing the tab of the baffle, such that the proximal end of the baffle is fixed relative to the first and second electrodes and a distal end of the baffle is free to move toward and away from the first and second electrodes.

4. The capacitance manometer of claim 1, wherein the baffle comprises graphite.

5. The capacitance manometer of claim 1, wherein the first and second electrodes are housed in a graphite block and the proximal end of the baffle is clamped to the block.

6. The capacitance manometer of claim 5, further comprising a plurality of insulating separators electrically isolating the first and second electrodes from each other and from the graphite block.

7. The capacitance manometer of claim 6, wherein each of the insulating separators comprises a ceramic tube having an open end adjacent the second face of the baffle.

8. The capacitance manometer of claim 1, further comprising an integral heating element.

9. A system for measuring differential vacuum pressure, the system comprising:
a capacitance manometer including a first electrode and a second electrode adjacent a flexible, electrically-conductive baffle secured at a proximal end and free at a distal end, such that the distal end of the baffle is configured to flex toward and away from the first and second electrodes with a magnitude of flexion corresponding to a differential pressure across the baffle;
a time-varying voltage source coupled to the baffle, such that the baffle forms a first capacitor in combination with the first electrode and a second capacitor in combination with the second electrode; and
a measuring circuit configured to receive a first current measured on the first electrode and a second current measured on the second electrode, and to convert a difference between the first and second currents into a measurement of the differential pressure across the first and second faces of the baffle.

10. The system of claim 9, further comprising:
a tab extending from the proximal end of the baffle; and
a fastener securing the tab of the baffle, such that the proximal end of the baffle is fixed relative to the first and second electrodes.

11. The system of claim 9, wherein the baffle comprises graphite.

12. The system of claim 9, wherein the first and second electrodes are housed in a graphite block and the proximal end of the baffle is clamped to the graphite block.

13. The system of claim 12, wherein the proximal end of the baffle comprises an extension, and the extension is clamped to the graphite block between a pair of insulating plates.

14. The system of claim 12, further comprising a plurality of insulating separators electrically isolating the first and second electrodes from each other and from the graphite block.

15. The system of claim 14, wherein each of the insulating separators comprises a ceramic tube having an open end adjacent the second face of the baffle.

16. The system of claim 9, wherein each of the first and second electrodes has a respective end adjacent the baffle, and the respective ends are coplanar.

17. A method for measuring differential vacuum pressure between two compartments, the method comprising:
sensing, using a capacitance manometer, a differential pressure between a first compartment and a second compartment, wherein the capacitance manometer includes a first electrode and a second electrode adjacent a flexible, electrically-conductive baffle secured at a proximal end and free at a distal end, such that the distal end of the baffle is configured to flex toward and away from the first and second electrodes with a magnitude of flexion corresponding to the differential pressure;
producing a first current in the first electrode and a second current in the second electrode by applying a time-varying voltage source to the baffle of the capacitance manometer, such that the baffle forms a first capacitor in combination with the first electrode and a second capacitor in combination with the second electrode; and
converting a difference between the first current and the second current into a measurement of the differential pressure.

18. The method of claim 17, wherein the capacitance manometer further comprises:
a tab extending from the proximal end of the baffle; and
a fastener securing the tab of the baffle, such that the proximal end of the baffle is fixed relative to the first and second electrodes.

19. The method of claim 17, wherein the baffle comprises graphite.

20. The method of claim 17, further comprising:
housing the first and second electrodes in a block of graphite; and
clamping the proximal end of the baffle to the block of graphite.
